(19) United States
(12) Patent Application Publication
(10) Pub. No.: US 2005/0097023 A1
(43) Pub. Date: May 5, 2005

(54) Method for issuing a derivative contract

(75) Inventor: Alan R. Kaufman, Princeton, NJ (US)

Correspondence Address: Daniel H.Golub, 1701 Market Street, Philadelphia, PA, 19103, US

(73) Assignee: Assetsight, Inc., Princeton, NJ (US)

(21) Appl. No.: 11/013,983

(22) Filed: Dec. 16, 2004

Related U.S. Application Data
(63) Continuation of application No. 09/900,106, filed on Jul. 6, 2001.

(51) Int. Cl. G06F 17/60

(52) U.S. Cl. 705/36

(57) ABSTRACT

A method for issuing a derivative contract to a buyer includes providing an index that represents a measure of commercial market volatility, assigning a target value for the index at an expiration of the derivative, identifying a premium for the derivative contract, estimating a return value to pay a buyer at the expiration if the target value is attained, and issuing the derivative contract to the buyer in accordance with the premium, expiration, and return value.

### FIELD OF INVENTION

This invention relates to the field of securities and more specifically, is directed to issuing derivative contracts.

### BACKGROUND

Interest in the securities market has increased over the years. Investors may desire greater returns on their assets, so they may often seek alternative investments. One way investors may analyze different markets is by indices. An index reports changes, usually expressed as a percentage, in a specific financial market, in a number of related markets, or in the economy as a whole. Each index measures the market or markets it tracks from a specific starting point, which might be as recent as the previous day or many years in the past. Consequently, two indexes tracking similar markets may report different numbers.

Two indices may also produce different results because some indices are weighted and others are not. Weighting means giving more significance to some elements in the index than to others. For example, a market capitalization index weighs larger companies more than smaller companies.

One type of investment based on an index is an index mutual fund. An index mutual fund may be designed to mirror the performance of a major stock or bond index, such as Standard & Poor's 500-stock Index (S&P 500®) or the Russell 2000®, by purchasing all of the securities included in the index or a representative sample of them. It is believed that each index fund aims to keep pace with an index, but not to outperform it. This strategy may be successful during a bull market when an index reflects increasing prices. However, it may produce disappointing returns during economic downturns when an actively managed fund might take advantage of investment opportunities where and when they arise.

An index fund's broadbased portfolio may not be actively managed, so the index funds may have lower-than-average management costs and smaller expense ratios. That means less of the fund's growth may go to pay expenses, and more may be returned to the fund's investors. However, not all index funds provide the same level of performance.

Another type of investment using an index is an index option. Index options may allow investors the chance to earn (or lose) money by anticipating the gains or losses in an industry group or a broader segment of the market. For example, an investor who thinks technology stocks are going to fall can buy an option on a technology index, rather than selling short a number of different technology stocks. Trading in index options may occur on the New York Stock Exchange (NYSE®), the American Stock Exchange (AMEX®), the Chicago Board Options Exchange (CBOE®), or other exchanges.

### SUMMARY OF THE INVENTION

The invention provides a method for issuing a derivative contract to a buyer. This method may include providing an index that represents a measure of commercial market volatility, assigning a target value for the index at an expiration of the derivative contract, identifying a premium for the derivative contract, estimating a return value to pay a buyer at the expiration if the target value is attained, and issuing the derivative contract to the buyer in accordance with the premium, expiration, and return value.

The invention also provides another method for issuing a derivative contract to a buyer. This method may include providing an index that represents a measure of commercial market volatility, assigning a target value for the index at an expiration of the derivative contract, identifying a premium for the derivative contract, estimating a return value to pay the buyer at the expiration if the target value is attained, issuing the derivative contract to the buyer in accordance with the premium, expiration, and return value, trading the derivative contract on an exchange, and charging an exchange fee for selling or purchasing the derivative contract. The index includes commercial markets chosen from sectors, including currencies, financials, grains, metals, meat, softs, energy, and combinations thereof.

The invention provides a system for issuing a derivative contract to a buyer. This system may include a database for storing market data used to calculate an index that represents a measure of commercial market volatility, and a processor that calculates the index, associates a target value with the index at an expiration of the derivative contract, associates a premium with the derivative contract, estimates a return value to pay a buyer at the expiration if the target value is attained, and issues the derivative contract to the buyer in accordance with the premium, expiration, and return value.

The invention further provides another system for issuing a derivative contract to a buyer. This system may include a database for storing market data for commercial markets used to calculate an index that represents a measure of commercial market volatility, and a processor that calculates the index, associates a target value with the index at an expiration of the derivative contract, associates a premium with the derivative contract, estimates a return value to pay a buyer at the expiration if the target value is attained, and issues the derivative contract to the buyer in accordance with the premium, expiration, and return value. The index includes commercial markets chosen from sectors, including currencies, financials, grains, metals, meat, softs, energy, and combinations thereof.

### BRIEF DESCRIPTION OF THE DRAWINGS

The accompanying drawings, which are incorporated herein and constitute part of this specification, illustrate the presently preferred embodiment of the invention and, together with the general description given above and the detailed description given below, serve to explain the features of the invention:

FIG. 1 is a block diagram of a preferred embodiment of the present invention.

FIG. 2 is a block diagram of a system for implementing the preferred embodiment of the present invention.

FIGS. 3a and 3b are graphs illustrating comparative unit asset values of the preferred embodiment of the present invention.

### DETAILED DESCRIPTION OF THE PREFERRED EMBODIMENTS

Reference will now be made in detail to the preferred embodiments of the present invention, an example of which is illustrated in the accompanying drawings. It is to be understood that the Figures and description of the present invention included herein illustrate and describe elements that are of particular relevance to the present invention, while eliminating, for purposes of clarity, other elements found in typical derivative contracts and indices.

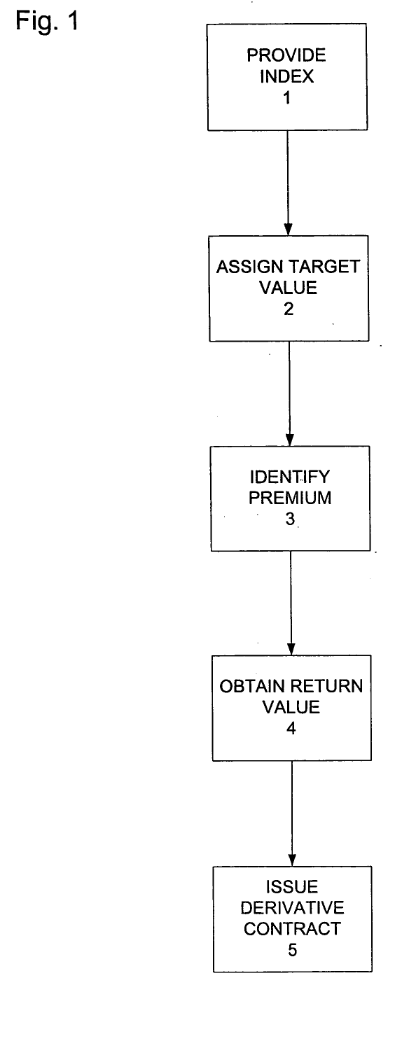

FIG. 1 illustrates a method of issuing a derivative contract to a buyer. In step 1, an index that represents a measure of commercial volatility is provided. Preferably, the index includes a portfolio of commercial markets chosen from sectors, including currencies, financials, and commodities. More preferably, the portfolio has about twenty-five (25) commercial markets.

Commercial markets differ from investment markets. In general, three kinds of participants exist in any market: hedgers, speculators (investors), and arbitrageurs. The role of arbitrageurs is to profit from price inefficiencies, and in return, provide liquidity. Hedgers are commercial producers or consumers of a commodity who hedge their price risk by transferring it to another entity. The investor's role specifically in relationship to the hedgers is to take the opposite position of the commercial hedgers, which is accepting price volatility. In return, the investor receives a premium, which is similar to an insurance company being paid a premium in return for accepting event risk. Thus, the investor generates return by accepting the excessive price risk to which commercial hedgers are naturally exposed, but unwilling to take. Traditional investment markets (i.e., equities) serve an economic function of capital formation for companies. They are typically dominated by long term investors who buy and hold their positions. In contrast, commercial markets, or principally commodities, serve to meet the needs of consumers and producers and are dominated by commercial interests selling their production, acquiring raw materials, and hedging themselves against price risk.

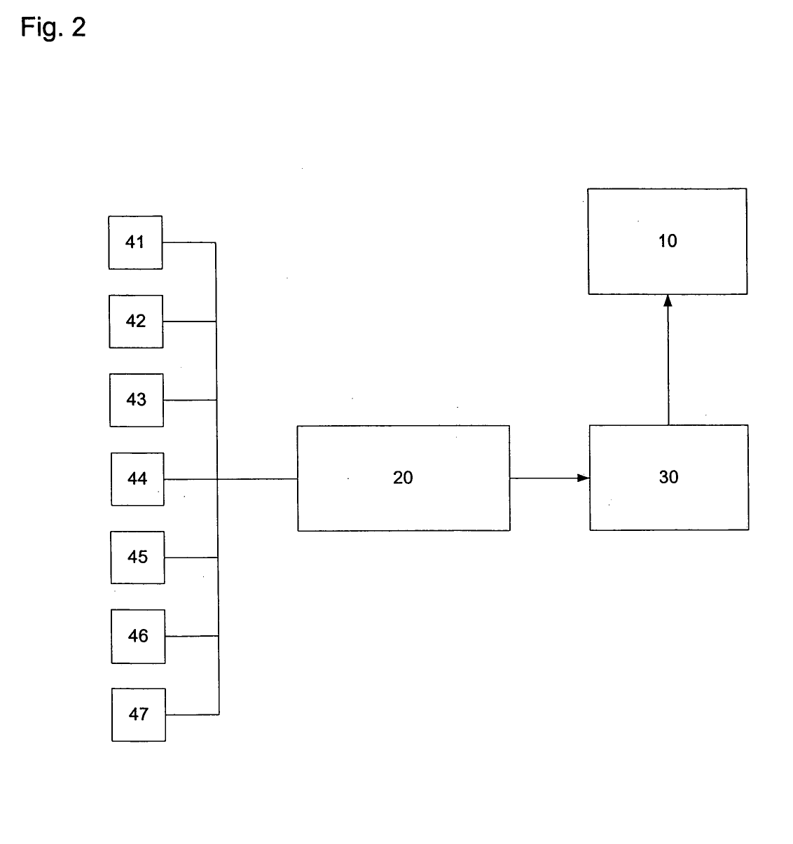

In one embodiment, as shown in FIG. 2, the index 10 is determined by using equal weighted, unleveraged investments from the commercial markets. Database 20 stores information, or market data, used to calculate the index 10. The index 10 is calculated by a processor 30. The market data may include the values of investments in commercial markets or preferably, the exchange on which the market is traded, the market value, the unit asset value, long and short term signals, and contract information. The index 10 used in one embodiment is further described in “The Commercial Markets Index,” which is incorporated herein by reference and attached hereto as Exhibit A.

Preferably, markets are selected for inclusion in the index 10 according to liquidity, investability, and diversification. Markets that are liquid have an open interest large enough to guarantee timely execution of position changes and large enough to accommodate large amounts of capital with low market impact. The index 10 excludes contracts that trade in excessively large lot sizes, which are considered to have a low investability, to allow downward scalability of investment. Markets are also chosen to maximize diversification benefits and avoid over-concentration in any market or sector.

For example, the sectors in the index 10 may include currencies 41, energy 42, financials 43, grains 44, metals 45, softs 46, and meat 47. The markets in the currencies sector may include the Australian Dollar, British Pound, Canadian Dollar, Euro, Japanese Yen, and Swiss Franc. The markets in the energy sector may include crude oil, heating oil, natural gas and unleaded gas, and the markets in the financials sector may include US 30-year bonds, US 10-year bonds and US 5-year bonds. Markets, which may be in the grains sector, include corn, wheat, soybeans, soybean oil, and soybean meal. Copper, gold, and silver may be the markets for the metals sector. The markets for the softs sector may include coffee, cotton, and sugar, and the market for the meat sector may be live cattle. These markets may be traded on any exchange, such as IMM®, NYMEX®, CBOT®, CSCE, COMEX®, NYBOT®, and CME®.

In the preferred embodiment, the index 10 is developed by taking long and short positions to reflect a full range of hedger activity driving returns in markets. An investment benchmark of returns available to a momentum strategy applied to the portfolio may be provided to investors. All individual contracts in the index 10 are rolled forward regularly to maintain market exposure beyond the contracts' expiration dates. The roll strategy may attempt to follow actual market hedger activity or may follow the relative movement of open interest across the actively traded contracts of a given market. All contracts are held for a minimum of ten (10) trading days.

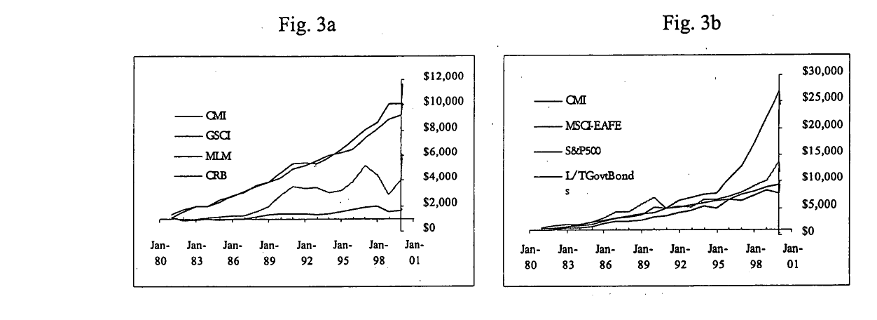

The index 10 produces long and short signals using a trend-following algorithm. The index 10 uses unit asset value (“UAV”) for generating signals. The UAV is calculated per market, daily, as follows:
UAV_{(today)}=UAV_{(yesterday)}×(1+Pct Chg(Closing Price))
where:
Pct Chg(Closing Price)=(Close_{(today)}−Close_{(yesterday)}/Close_{(yesterday)})
Signals for all markets are evaluated every four weeks, and signals are generated for each market when 13 weeks of data are available. This algorithm is described in more detail in “The Commercial Markets Index” attached hereto. Comparative UAVs based on annual return from 1980 to 2000 are shown in FIGS. 3a and 3b. FIG. 3a shows a graph of the index (“CMI”) compared to other commercial market indices, and FIG. 3b shows a graph of the CMI compared to traditional capital market indices.

A market value curve is constructed from the UAV values. At any point in time, the market value is:
MVₜ=MVₜ₋₁+[(UAVₜ−UAVₜ₋₁)×POSₜ×AFₜ]
where:
MVₜ=Market value at time t;
MVₜ₋₁=Market value at time t−1;
UAVₜ=UAV at time t;
UAVₜ₋₁=UAV at time t−1;
POSₜ=Position at time t;
MV₀=Market value at time (0)=UAV on the day prior to market entry; and

$${AF}_{t} = \frac{{MV}_{t}}{{UAV}_{t - 1}} = Adjustment factor at time t .$$

The adjustment factor only changes when an index market position moves from a short to a long position; The market value is further explained in “The Commercial Markets Index” attached hereto.

As illustrated in FIG. 1, after the index is calculated in step 1, a target value for the index at an expiration of the derivative contract is assigned in step 2. A premium is identified in step 3, and a return value to pay buyer at the expiration if the target value is obtained is estimated in step 4. In step 5, the derivative contract is issued to the buyer in accordance with the premium, expiration, and return value. Steps 2-5 may be implemented by the processor 30 shown in FIG. 2.

In the preferred embodiment, the buyer pays the seller for the derivative contract. The derivative contract may be traded on an exchange, and a fee may be charged for selling or purchasing the derivative contract. Examples of derivative contracts include:
Exchange traded futures contracts
Exchange traded options on futures contracts
Exchange traded and over-the-counter swap agreements
Exchange traded option agreements
ETF's (Exchange Traded Funds)
Average price options
Look back options
Index Linked Structured Notes.

In the preferred embodiment, the contract specifications for trading on an exchange include:

| | |
|---|---|
| Trading Unit: | $5 × the Commercial Markets Index (CMI) |
| | (approx. current contract value: $66,500) |
| Trading Hours: | 9:40 am to 3:15 pm |
| Contract Months: | January, February, April, June, August, |
| | November |
| Ticker Symbol: | CB |
| Minimum Fluctuation: | 1 CMI point, or $5.00 per contract |
| Price Quotation: | Prices shall be quoted as whole Index points |
| Last Trading Day: | Second Friday of the expiring contract month |
| Settlement: | Cash Settlement |
| Position Limits: | 10,000 contracts net long or short. |

While the invention has been described in detail and with reference to specific features, it will be apparent to one skilled in the art that various changes and modifications can be made therein without departing from the spirit and scope of the invention. It is intended that the present invention cover the modifications and variations of this invention provided they come within the scope of the appended claims and their equivalents.

### Exhibit A

The Commercial Markets Index

The Commercial Markets Index is a benchmark of the returns available to a momentum strategy applied to a broadly diversified, unleveraged and equal-weighted portfolio of commercial markets. Currently, the Index maintains investments in 25 of the most liquid commercial markets, including currencies, financials, and a broad range of commodities.

The Commercial Markets Index is made available as the CMI Total Return Index, the CMI Price Index and the CMI Sector Indices (Currency, Energy, Financial, Grain, Meat, Metal, and Softs). The monthly rate of return for the CMI Total Return Index equals the arithmetic average of the individual market monthly rates of return plus the risk-free rate of return (US 30 day T-bill Total Return; Source: Ibbotson). The CMI Price Index and Sector Indices do not include interest income. All indices are initialized to 1000 on Dec. 31, 1969.

Market Inclusion

The CMI includes a broad spectrum of commercial markets, thus maximizing diversification benefits without overly concentrating in any one sector. All markets are traded on C.F.T.C.-approved U.S. exchanges.

A CMI Policy Committee meets annually to determine the markets that will be included in the CMI for the following year, in accordance with a specific set of guidelines. Committee members include senior representatives from major pension plans, banks, institutional investment managers, and pension consultants. The meetings are held in September, results are announced in October and take effect the following January.

Markets are selected for inclusion in the CMI according to the following criteria:
Liquidity. The primary criterion for inclusion in the CMI is liquidity, that is, open interest large enough to guarantee timely execution of position changes and large enough to accommodate large amounts of capital with low market impact.
Investability. The CMI excludes contracts that trade in excessively large lot sizes, in order to allow downward scalability of investment.
Diversification. Markets also are chosen so as to maximize diversification benefits and avoid over-concentration in any given market or sector.

Currently, the Index is comprised of the markets described in Table 1 below. See Exhibit A1 for the full constituent history.

TABLE 1
Sectors and Markets in the Commercial Markets Index - 2001

| | | | | |
|---|---|---|---|---|
| | | Data | | |
| | | Start | First | |
| Market | Exchange | Date | Contract | Contract Months |

| | | | | |
|---|---|---|---|---|
| Currencies | | | | |
| Australian Dollar | IMM-CME | Jan. 13, 1987 | March 1987 | March, June, September, December |
| British Pound | IMM-CME | May 16, 1972 | September 1972 | March, June, September, December |
| Canadian Dollar | IMM-CME | May 16, 1972 | September 1972 | March, June, September, December |
| Euro | IMM-CME | Oct. 1, 1999 | December 1999 | March, June, September, December |
| Japanese Yen | IMM-CME | May 16, 1972 | September 1972 | March, June, September, December |
| Swiss Franc | IMM-CME | May 16, 1972 | September 1972 | March, June, September, December |
| Energy | | | | |
| Crude Oil-Lt Swt | NYMEX | Mar. 30, 1983 | June 1983 | All |
| Heating Oil | NYMEX | Nov. 15, 1978 | February 1979 | All |
| Natural Gas-HH | NYMEX | Apr. 3, 1990 | June 1990 | All |
| Unleaded Gas-NYH | NYMEX | Dec. 31, 1984 | February 1985 | All |
| Financials | | | | |
| US 30-yr Bond | CBOT | Aug. 22, 1977 | December 1977 | March, June, September, December |
| US 10-yr Bond | CBOT | May 3, 1982 | June 1982 | March, June, September, December |
| US 5-yr Bond | CBOT | May 20, 1988 | September 1988 | March, June, September, December |
| Grains | | | | |
| Corn | CBOT | Jan. 2, 1969 | March 1969 | March, May, July, September, December |
| Wheat | CBOT | Jan. 2, 1969 | March 1969 | March, May, July, September, December |
| Soybeans | CBOT | Jan. 2, 1969 | May 1969 | January, March, May, July, August, September, November |
| Soybean Oil | CBOT | Jan. 2, 1969 | March 1969 | January, March, May, July, August, September, October, |
| | | | | December |
| Soybean Meal | CBOT | Jan. 2, 1969 | March 1969 | January, March, May, July, August, September, October, |
| | | | | December |
| Metals | | | | |
| Copper | COMEX | Jan. 2, 1969 | March 1969 | March, May, July, September, December |
| Gold | COMEX | Jan. 2, 1975 | February 1975 | February, April, June, August, October, December |
| Silver | COMEX | Jan. 2, 1969 | September 1969 | March, May, July, September, December |
| Softs | | | | |
| Coffee | CSCE | Oct. 10, 1972 | December 1972 | March, May, July, September, December |
| Cotton | NYCE | Jan. 2, 1969 | March 1969 | March, May, July, October, December |
| Sugar #11 | CSCE | Jan. 2, 1969 | March 1969 | March, May, July, October |
| Meat | | | | |
| Live Cattle | CME | Jan. 2, 1969 | February 1969 | February, April, June, August, October, December |

Exhibit A2 at the rear of the document gives further contract details for each of the markets currently included in the CMI.

Roll Strategy

All individual contracts in the Index must be rolled forward regularly in order to maintain market exposure beyond the contracts' expiration dates. The roll strategy is defined so as to maintain liquidity while providing a smooth and rational transition from contract to contract. The CMI's roll strategy attempts to follow actual market hedger activity as closely as possible. In practice, the roll strategy follows the relative movement of open interest across the actively traded contracts of a given market.

The relatively short contract life and the specific characteristics of some market price data require certain additional constraints on the rolling implementation. All contracts must be held a minimum of ten (10) trading days. From the tenth day of trading, the Index rolls into the deferred contract according to logic that defines a rolling evaluation window, an open-interest trigger, and a time-based trigger.

Rolling Evaluation Window

The methodology defines a window within which evaluation for potential rolling can be made for each market. A roll is defined here as the first day that the Index no longer holds the old contract and that it holds a new contract. The first day of the evaluation window is the thirtieth (30) calendar day before the first day of the contract expiration month. Idiosyncrasies in individual markets and market sectors fix the last day of the window differently for each market, according to the categories listed in Table 2.

TABLE 2
Defining the Last Day of the Rolling Evaluation Window

| | | Last day of rolling |
|---|---|---|
| Market | | evaluation window |
| Crude Oil | Coffee | 20 calendar days before the first |
| | | day of the contract expiration |
| | | month |
| Heating Oil | Cotton | 15 calendar days before |
| Unleaded Gasoline | | |
| Natural Gas | | |
| Corn | 5-Year Notes | 10 calendar days before |
| Soybean Oil | 10-Year Notes | |
| Soybeans | 30-Year Bonds | |
| Soybean Meal | | |
| Wheat | Gold | |
| Sugar | Copper | |
| Live Cattle | Silver | |
| Australian Dollar | Euro | 5 calendar days after |
| British Pound | Japanese Yen | |
| Canadian Dollar | Swiss Franc | |

A roll signal occurs within the evaluation window based on the following triggers:

Open-Interest Trigger

A roll is triggered when the amount of open interest in-any of the nearest three deferred contracts (see exceptions below) matches or exceeds that of the currently held contract. The Index then rolls to the contract with the greatest open interest. If two forward contracts have the same open interest value, the nearer of the two is flagged for entry.

If a forward contract has no open interest data for the day being analyzed, the Index scans up to three (3) previous trading days for that contract for a valid open interest value. This open interest value is used in the comparison to determine a roll signal. If there are no valid open interest values in this three-day period, the Index uses an open interest value of zero (0) for that contract.

Exceptions: Special market circumstances call for exceptions in how many nearby contract months are eligible for the roll, as listed in Table 3 below.

TABLE 3
Open Interest Trigger Exception List

| Market(s) | Description |
|---|---|
| Australian Dollar | Only 1 nearby contract month is |
| British Pound | eligible for rolling forward |
| Canadian Dollar | |
| Euro | |
| Japanese Yen | |
| Swiss Franc | |
| 5 Year Note | |
| 10 Year Note | |
| US Bond | |

Time-Based Trigger

In order to maintain liquidity, the Index avoids holding a position in a contract too close to the contract's expiration date. Thus, the methodology forces a roll signal on the last day of the rolling evaluation window.

When this date falls on a weekend or holiday, a roll is signaled on the next available trading day. When the last day of the evaluation window is reached, the roll strategy targets the contract month with the highest level of open interest, or the closest nearby month if open interest data is missing.

Roll Time-Line

The systematic implementation of the roll requires a step-by-step process that necessarily involves a practical time lag between when data is first reported and when an actual position is in place (that is, when a roll, as herein defined, occurs). Please refer to Table 4 below. The Index assumes that open interest crosses during the market day on Day 1 and is reported after the close on Day 2 (since open interest is reported with a one-day lag). After the data is available on Day 2, evaluation is made for possible triggers as defined above. On Day 3, the Index enters into the new contract at the close and on Day 4, a roll occurs.

TABLE 4
Rolling Implementation Timeline

| | Day 1 | Day 2 | Day 3 | Day 4 |
|---|---|---|---|---|
| Market | Open interest | | New contract entry | New contract held. |
| Day: | actually crosses. | | on close. | Roll occurs. |
| Post | | Open interest cross | | |
| Close: | | reported. Evaluate | | |
| | | for possible trigger | | |
| | | generation- | | |
| | | assuming the | | |
| | | current date falls | | |
| | | within the | | |
| | | evaluation window. | | |

First Contract

There may be more than one contract available on a market's first day of price data. Table 1 includes a list of the first contracts that were selected for use in the CMI.

Signal Generation

The Index produces long/short signals using a simple trend-following algorithm. Because of the price jumps created by contract rolls, the-Index uses Unit Asset Value for generating signals, rather than raw price data.

Unit Asset Value

In order to create a continuous time series derived from actual prices, a unit asset value (UAV) is calculated per market, daily, as follows:
UAV_{(today)}=UAV_{(yesterday)}*(1+PctChg(Closing Price))
Where:
PctChg(Closing Price)=(Close_{(today)}−Close_{(yesterday)})/Close_{(yesterday)}
Note: PctChg is always calculated using the closing prices of the currently held contract. (If the Index holds a new contract today, it uses yesterday's closing price of the new contract to calculate PctChg.)

The original UAV is set to 1000 on day 1 of each market's history. The choice to set the initial value of the UAV to 1000 is arbitrary; the daily percentage construction of the UAV guarantees that the shape of the UAV curve is identical regardless of initial value, and only the scaling along the Cartesian plane changes.

Signals for all markets are evaluated every four (4) weeks on a Tuesday night. Tuesday was chosen to avoid any potential weekend effects and also to minimize holiday interference. To ensure that all markets trade on the same four—(4) week intervals, a master calendar is synchronized to a Jan. 9, 1900 start date and all markets use this calendar for signal generation. Of course, data is not available for every market that far back. Signals are generated for a market when 13 weeks of data are available.

To determine a signal, a 13-week moving average of the UAV is calculated (i.e., the average of the past 13 Tuesdays' UAVs, including today's). If any of the Tuesdays is a holiday, the nearest previous UAV is used. Table 5 describes the conditions governing long/short signal generation.

TABLE 5
Conditions for Generating Long/Short Signals

| Evaluation | Signal |
|---|---|
| UAV > 13 week moving average | LONG signal is generated |
| UAV < 13 week moving average | SHORT signal is generated |
| UAV = 13 week moving average | Previous signal is maintained |

It is assumed that a signal generated on Tuesday night (using Tuesday's closing price) will be executed at the following trading day's close (usually Wednesday) and will result in a new position held on the second trading day following signal generation. Except for holidays, this would be Thursday. If there is no trading on that Thursday (e.g., Thursday is a holiday), the Index is considered exposed in the new position on the next trading day for which there is data.

The process as discussed so far creates one continuous UAV series per market, using the roll strategy as defined above to concatenate contracts. From each market UAV series, positions are derived that can be represented by a time series using a value of 1 to illustrate a trading day with long exposure and a value of −1 to illustrate a trading day with short exposure. These two times series are used to create a market value curve for each market.

Individual Market Value Curves

With one exception, constructing this market value curve can be done in a straightforward manner, once a series of daily positions has been established for each market. The exception results when an Index market position shifts from short to long. Consider the trading scenario depicted in Table 6.

TABLE 6
Effect of Position Change on Market Value

| Date | UAV | Position | Market Value |
|---|---|---|---|
| Jan. 3, 1950 | 1000 | 1 | 1000 |
| Jan. 4, 1950 | 1100 | 1 | 1100 |
| Jan. 5, 1950 | 1200 | 1 | 1200 |
| Jan. 6, 1950 | 1300 | −1 | 1100 |
| Jan. 9, 1950 | 1400 | −1 | 1000 |
| Jan. 10, 1950 | 1500 | −1 | 900 |
| Jan. 11, 1950 | 1600 | −1 | 800 |
| Jan. 12, 1950 | 1700 | −1 | 700 |
| Jan. 13, 1950 | 1800 | 1 | 741.2 |

Notice what happens for the period between January 3 and January 5: the Market Value curve is exactly identical to the UAV. The reason is straightforward; since the Index market position is long, a positive change in price and UAV is a positive change in market value.

From January 6 through January 12, however, the asset continues to gain 100 in value each day, but now the Index market position has switched to a short position. Each increase in the UAV now represents an equal reduction on the Market Value curve.

On January 13, the Index market position switches back to long again, after ‘cashing out’ the short position for 700. When the Index market takes a new position on the long side of the UAV, it is no longer able to ‘purchase’ one ‘unit’. Rather, an investment of 700 translates to 700/1700, or 0.412 ‘units’. Thus, for every advance of 100 that the UAV makes, Market Value only moves 41.2; hence final Market Value on Jan. 13, 1950 becomes 741.2.

To represent this change in the share of the market UAV with which the Market Value now participates, the process maintains a running “Market Value Adjustment Factor” to use as a multiplier to the UAV percentage change. This makes it possible to accurately track the market's value over time, simulating what would be occurring in reality. This adjustment factor is updated upon a signal change and also following the close of the last trading day of the month.

The adjustment factor is defined as follows:

$${AF}_{t} = \frac{{MV}_{t - 1}}{{UAV}_{t - 1}}$$

Where:
AFₜ=Adjustment factor at time t
MVₜ₋₁=Market Value at time t−1
UAVₜ₋₁=Unit Asset Value at time t−1

As a mathematical consequence, the adjustment factor only changes when an Index market position moves from a short to a long position.

Additionally, the definition of our Market Value at any point in time is as follows:
MVₜ=MVₜ₋₁+[(UAVₜ−UAVₜ₋₁)*POS*AFₜ]
Where:
MVₜ=Market Value at time t
MVₜ₋₁=Market Value at time t−1
UAVₜ=UAV at time t
UAVₜ₋₁=UAV at time t−1
POSₜ=Position at time t
AFₜ=Adjustment Factor at time t
MV₀=Market Value at time (0)=UAV on the day prior to market entry
   Rates of Return
   Rebalancing

The CMI is an equal-weighted Index; however, price movements in the underlying markets make regular rebalancing necessary. The CMI uses a calendar monthly rebalancing scenario. In other words, investment in each of the Index markets is equal at the beginning of the month, diverging as losses or gains occur uniquely in each market, then re-balanced to equal weights at the beginning of the next month.

In the historical time series, when markets have joined the Index intra-month, monthly rebalancing assumes that their inclusion is ‘known’ at the beginning of the month. Thus, the new market receives an equal allocation for that month accordingly, has zero returns until the market joins, and the rate of return is included in that month's average.

Daily Returns

The calculation of daily CMI returns must account for the fact that intra-month market weightings diverge from 1/25. Thus, individual market weights are tracked and used to derive daily returns for the CMI Price Index.

Monthly & Annual Returns

The monthly and annual returns for the CMI Price Index are simply the average of the individual market monthly or annual rates of return.

All Indices are initialized to 1000 on Dec. 31, 1969.

The CMI Total Return is provided monthly and equals the CMI Price Index plus the US risk-free interest rate (Ibbotson Associates 30-day T-bill return).

### Exhibit A1

Contract Details for CMI Markets (2001)

| | | Trading Hours | Date included | | Contract Size |
|---|---|---|---|---|---|
| Market | Exchange | (EST) | in the CMI | Contract Price Unit | and Units |
| Currencies | | | | | |
| Australian Dollar | IMM-CME | 8.20 am-3.00 pm | April 1987 | US$/AD | 100,000 AD |
| British Pound | IMM-CME | 8.20 am-3.00 pm | August 1972 | US$/BP | 62,500 BP |
| Canadian Dollar | IMM-CME | 8.20 am-3.00 pm | August 1972 | US$/CD | 100,000 CD |
| Euro | IMM-CME | 8.20 am-3.00 pm | January 2000 | US$/Euro | 125,000 Euro |
| Japanese Yen | IMM-CME | 8.20 am-3.00 pm | August 1972 | US$/JY | 12,500,000 JY |
| Swiss Franc | IMM-CME | 8.20 am-3.00 pm | August 1972 | US$/SF | 125,000 SF |
| Energy | | | | | |
| Crude Oil-Lt Swt | NYMEX | 9:45 am-3:10 pm | July 1983 | $/bbl. | 1,000 bbls. |
| Heating Oil | NYMEX | 9:50 am-3:10 pm | February 1979 | ¢/gal. | 42,000 gallons |
| Natural Gas-HH | NYMEX | 10:00 am-3:10 pm | June 1990 | $/MMBtu | 10,000 MMBtu |
| Unleaded Gas-NYH | NYMEX | 9:50 am-3:10 pm | March 1985 | ¢/gal. | 42,000 gallons |
| Financials | | | | | |
| US 30-yr Bond | CBOT | 8:20 am-3:00 pm | December 1977 | Points($1,000) & 1/32's | $100,000 face value |
| US 10-yr Bond | CBOT | 8:20 am-3:00 pm | August 1982 | Points($1,000) & 1/32's | $100,000 face value |
| US 5-yr Bond | CBOT | 8:20 am-3:00 pm | August 1988 | Points($1,000) & ½ of 1/32 | $100,000 face value |
| Grains | | | | | |
| Corn | CBOT | 10:30 am-2:15 pm | April 1969 | ¢/bu. | 5,000 bu. |
| Wheat | CBOT | 10:30 am-2:15 pm | April 1969 | ¢/bu. | 5,000 bu. |
| Soybeans | CBOT | 10:30 am-2:15 pm | April 1969 | ¢/bu. | 5,000 bu. |
| Soybean Oil | CBOT | 10:30 am-2:15 pm | April 1969 | $/lb. | 60,000 lb |
| Soybean Meal | CBOT | 10:30 am-2:15 pm | April 1969 | $/ton | 100 tons |
| Metals | | | | | |
| Copper | COMEX | 8:10 am-2:00 pm | April 1969 | ¢/lb | 25,000 lb. |
| Gold | COMEX | 8:20 am-2:30 pm | April 1975 | $/Troy oz. | 100 Troy oz. |
| Silver | COMEX | 8:25 am-2:25 pm | April 1969 | ¢/Troy oz. | 5000 Troy oz. |
| Softs | | | | | |
| Coffee | CSCE | 9:15 am-1:32 pm | January 1973 | ¢/lb. | 37,500 lbs. |
| Cotton | NYCE | 10:30 am-2:40 pm | April 1969 | ¢/lb. | 50,000 lbs. |
| Sugar#11 | CSCE | 9:30 am-1:20 pm | April 1969 | 1/100¢/lb. | 112,000 lbs. |
| Meat | | | | | |
| Live Cattle | CME | 10:05 am-2.00 pm | April 1969 | ¢/lb. | 40,000 lbs. |

| Market Changes | Exchange | Date Included | Date Removed | Comments |
|---|---|---|---|---|
| Deutsche Mark | IMM-CME | August 1972 | January 2000 | Replaced by the Euro. |

### Exhibit A2

Summary Statistics for 1970-2000

| | | | MLM | MSCI | S&P | LT Govt |
|---|---|---|---|---|---|---|
| | CMI- | GSCI- | Index- | EAFE- | 500- | Bonds- |
| | TR | TR | TR | TR | TR | TR |
| Average Monthly Return | 1.272 | 1.140 | 1.235 | 0.921 | 1.116 | 0.790 |
| Min Monthly Return | −5.778 | −15.635 | −15.326 | −18.383 | −21.520 | −8.410 |
| Max Monthly Return | 15.184 | 25.772 | 24.645 | 16.069 | 16.570 | 15.230 |
| # Negative Return Months | 100.000 | 156.000 | 105.000 | 129.000 | 142.000 | 151.000 |
| % Negative Return Months | 26.882 | 41.935 | 28.226 | 34.677 | 38.172 | 40.591 |
| Average of Negative Monthly Returns | −1.176 | −3.270 | −2.019 | −3.288 | −3.146 | −1.918 |
| Median of Negative Monthly Return | −0.935 | −2.254 | −1.420 | −2.303 | −2.265 | −1.500 |
| # Positive Return Months | 272.000 | 216.000 | 267.000 | 243.000 | 230.000 | 221.000 |
| % Positive Return Months | 75.556 | 60.000 | 74.167 | 67.500 | 63.889 | 61.389 |
| Average of Positive Monthly Returns | 2.171 | 4.325 | 2.515 | 3.155 | 3.747 | 2.640 |
| Median of Positive Monthly Return | 1.574 | 3.485 | 1.786 | 2.714 | 3.385 | 2.180 |
| Expected Monthly Return | 1.324 | 1.224 | 1.295 | 0.989 | 1.193 | 0.842 |
| Semi-deviation (−) | 1.067 | 3.081 | 2.129 | 3.172 | 3.052 | 1.657 |
| Avg Ret/Semi-deviation | 1.192 | 0.370 | 0.580 | 0.290 | 0.366 | 0.477 |
| Standard Deviation | 2.411 | 5.247 | 3.292 | 4.128 | 4.451 | 3.026 |
| Skewness | 1.496 | 0.645 | 1.388 | −0.554 | −0.370 | 0.557 |
| Kurtosis | 6.168 | 3.051 | 12.209 | 2.604 | 2.181 | 2.302 |
| Average Quarterly Return | 3.874 | 3.503 | 3.806 | 2.836 | 3.438 | 2.375 |
| Min Quarterly Return | −5.321 | −30.670 | −14.818 | −26.930 | −29.533 | −14.514 |
| Max Quarterly Return | 32.381 | 55.165 | 56.176 | 28.532 | 26.736 | 24.368 |
| # Negative Return Quarters | 56.000 | 132.000 | 76.000 | 121.000 | 105.000 | 118.000 |
| % Negative Return Quarters | 15.135 | 35.676 | 20.541 | 32.703 | 28.378 | 31.892 |
| Avg. of Negative Quarters | −1.752 | −6.121 | −3.327 | −5.546 | −5.395 | −3.343 |
| Median of Negative Quarters | −1.498 | −4.467 | −2.229 | −3.938 | −3.839 | −2.441 |
| # Positive Return Quarters | 314.000 | 238.000 | 294.000 | 249.000 | 265.000 | 252.000 |
| % Positive Return Quarters | 84.865 | 64.324 | 79.459 | 67.297 | 71.622 | 68.108 |
| Avg. of Positive Quarters | 4.878 | 8.841 | 5.650 | 6.910 | 6.938 | 5.052 |
| Median of Positive Quarters | 3.995 | 6.928 | 4.381 | 5.989 | 5.792 | 4.029 |
| Expected Quarterly Return | 3.874 | 3.503 | 3.806 | 2.836 | 3.438 | 2.375 |
| Semi-deviation (−) | 1.383 | 5.595 | 3.303 | 5.380 | 5.468 | 2.886 |
| Avg Ret/Semi-deviation | 2.801 | 0.626 | 1.152 | 0.527 | 0.629 | 0.823 |
| Standard Deviation | 4.422 | 9.934 | 6.647 | 7.658 | 7.660 | 5.538 |
| Skewness | 1.451 | 0.594 | 2.478 | −0.448 | −0.422 | 0.524 |
| Kurtosis | 5.437 | 2.950 | 15.635 | 1.183 | 1.514 | 1.513 |
| Average Annual Return | 16.621 | 14.635 | 16.870 | 12.627 | 15.009 | 9.798 |
| Min Annual Return | −1.475 | −39.039 | −10.512 | −33.257 | −38.916 | −17.101 |
| Max Annual Return | 72.036 | 106.809 | 123.684 | 52.276 | 61.008 | 54.412 |
| # Negative Return Years | 6.000 | 100.000 | 29.000 | 78.000 | 59.000 | 66.000 |
| % Negative Return Years | 1.662 | 27.701 | 8.033 | 21.607 | 16.343 | 18.283 |
| Avg. of Negative Annual Returns | −0.835 | −11.211 | −2.294 | −10.901 | −9.728 | −4.914 |
| Median of Negative Annual Returns | −0.716 | −7.741 | −1.506 | −8.486 | −7.482 | −4.093 |
| # Positive Return Years | 355.000 | 243.000 | 332.000 | 283.000 | 302.000 | 283.000 |
| % Positive Return Years | 98.338 | 67.313 | 91.967 | 78.393 | 83.657 | 78.393 |
| Avg. of Positive Annual Returns | 16.916 | 23.342 | 18.544 | 19.112 | 19.841 | 13.652 |
| Median of Positive Annual Returns | 13.411 | 19.678 | 13.915 | 17.341 | 18.463 | 11.983 |
| Expected Annual Return | 16.635 | 15.712 | 17.055 | 14.982 | 16.599 | 10.703 |
| Semi-deviation (−) | 0.451 | 9.729 | 2.346 | 8.744 | 7.830 | 3.881 |
| Avg Ret/Semi-deviation | 36.886 | 1.504 | 7.190 | 1.444 | 1.917 | 2.525 |
| Standard Deviation | 12.919 | 23.449 | 19.551 | 16.528 | 15.701 | 11.893 |
| Skewness | 1.425 | 0.611 | 3.140 | −0.261 | −0.206 | 0.733 |
| Kurtosis | 2.222 | 0.896 | 12.455 | −0.039 | 0.216 | 0.917 |

TR = total return
*Data sources: Ibbotson, Barclay Trading Group

### Exhibit A3

Correlations of Annual Returns
1980-2000

| | | | Bridge | | Barclay | MSCI- | | LT Govt |
|---|---|---|---|---|---|---|---|---|
| | CMI | | CRB | MLM | CTA | EAFE | S&P500 | Bonds |
| | TR | GSCI TR | Index | Index | Index | TR | TR | TR |
| CMI TR | 1 | | | | | | | |
| GSCI TR | −0.178 | 1 | | | | | | |
| Bridge/CRB Index | −0.184 | 0.706 | 1 | | | | | |
| MLM Index | 0.563 | −0.235 | −0.446 | 1 | | | | |
| Barclay CTA Index | 0.664 | 0.058 | 0.344 | 0.110 | 1 | | | |
| MSCI-EAFE TR* | −0.086 | −0.156 | −0.063 | −0.144 | −0.034 | 1 | | |
| S&P500 TR | −0.158 | −0.113 | −0.007 | −0.397 | −0.037 | 0.506 | 1 | |
| Bonds TR | −0.131 | −0.114 | −0.181 | 0.190 | −0.238 | 0.098 | 0.300 | 1 |

1. A method for issuing a derivative contract to a buyer comprising:
providing an index that represents a measure of commercial market volatility.;
assigning a target value for the index at an expiration of the derivative contract;
identifying a premium for the derivative contract;
estimating a return value to pay the buyer at the expiration if the target value is attained; and
issuing the derivative contract to the buyer in accordance with the premium, expiration, and return value.

2. The method of claim 1 wherein the identifying comprises:
providing payment from a seller to the buyer.

3. The method of claim 1 wherein the providing comprises:
presenting an investment benchmark of returns available to a momentum strategy applied to a diversified portfolio of commercial market futures.

4. The method of claim 1 wherein the providing comprises:
determining the index in accordance with equal-weighted, unleveraged investments in commercial markets.

5. The method of claim 4 wherein the determining comprises:
choosing the commercial markets from sectors, the sectors including at least one of currencies, financials, grains, metals, meat, softs, energy, and combinations thereof.

6. The method of claim 1 wherein the providing comprises:
developing the index by taking long and short positions to reflect a range of hedger activity driving returns in markets.

7. The method of claim 1 wherein the providing comprises:
determining the index by selecting markets based on at least one of liquidity, investability, diversification, and combinations thereof.

8. The method of claim 1 further comprising:
trading the derivative contract on an exchange; and
charging an exchange fee for at least one of selling and purchasing the derivative contract.

9. A method for issuing a derivative contract to a buyer comprising:
providing an index that represents a measure of commercial market volatility the index including commercial markets chosen from sectors, the sectors including currencies, financials, grains, metals, meat, softs, energy, and combinations thereof;
assigning a target value for the index at an expiration of the derivative contract;
identifying a premium for the derivative contract;
estimating a return value to pay the buyer at the expiration if the target value is attained;
issuing the derivative contract to the buyer in accordance with the premium, expiration, and return value;
trading the derivative contract on an exchange; and
charging an exchange fee for at least one of selling and purchasing the derivative contract.

10. A system for issuing a derivative contract to a buyer comprising:
a database for storing market data used to calculate an index that represents a measure of commercial market volatility; and
a processor that calculates the index, associates a target value with the index at an expiration of the derivative contract, associates a premium with the derivative contract, estimates a return value to pay a buyer at the expiration if the target value is attained, and issues the derivative contract to the buyer in accordance with the premium, expiration, and return value.

11. The system of claim 10 wherein the derivative contract comprises at least one of futures contracts, options on futures contracts, and combinations thereof.

12. The system of claim 10 wherein the market data comprises values of investments in commercial markets.

13. The system of claim 12 wherein the commercial markets comprise markets chosen from sectors, the sectors including at least one of currencies, financials, grains, metals, meat, softs, energy, and combinations thereof.

14. The system of claim 10 wherein the index is calculated in accordance with a portfolio of commercial markets.

15. The system of claim 14 wherein the commercial markets comprise liquid markets.

16. The system of claim 10 wherein the index generates signals using a unit asset value.

17. The system of claim 16 wherein the unit asset value is calculated by the equation:
UAV_{(today)}=UAV_{(yesterday)}×(1+Pct Chg(Closing Price))
where:
Pct Chg(Closing Price)=(Close_{(today)}−Close_{(yesterday)}/Close_{(yesterday)})

18. The system of claim 17 further comprising a market value constructed from the unit asset value, wherein the market value is calculated from the equation:
MVₜ=MVₜ₋₁+[(UAVₜ−UAVₜ₋₁)×POSₜ×AFₜ]
where:
MVₜ=Market value at time t;
MVₜ₋₁=Market value at time t−1;
UAVₜ=UAV at time t;
UAVₜ₋₁=UAV at time t−1;
POSₜ=Position at time t;
MV₀=Market value at time (0)=UAV on the day prior to market entry; and
$${AF}_{t} = \frac{{MV}_{t}}{{UAV}_{t - 1}} = Adjustment factor at time t .$$

19. A system for issuing a derivative contract to a buyer comprising:
a database for storing market data for commercial markets used to calculate an index that represents a measure of commercial market volatility, the index including commercial markets chosen from sectors, the sectors including at least one of currencies, financials, grains, metals, meat, softs, energy, and combinations thereof; and
a processor that calculates the index, associates a target value with the index at an expiration of the derivative contract, associates a premium with the derivative contract, estimates a return value to pay a buyer at the expiration if the target value is attained, and issues the derivative contract to the buyer in accordance with the premium, expiration, and return value.
